(19) United States
(12) Patent Application Publication
(10) Pub. No.: US 2009/0235478 A1
(43) Pub. Date: Sep. 24, 2009

(54) LENS AND DISPLAY CLEANING DEVICE AND METHOD OF USE

(76) Inventor: Lan C. England, Midvale, UT (US)

Correspondence Address: BATEMAN IP LAW GROUP, P.O. BOX 1319, SALT LAKE CITY, UT, 84110, US

(21) Appl. No.: 12/274,853

(22) Filed: Nov. 20, 2008

Related U.S. Application Data
(60) Provisional application No. 60/989,550, filed on Nov. 21, 2007.

(51) Int. Cl. G02C 13/00; B32B 37/00

(52) U.S. Cl. 15/214; 156/60

(57) ABSTRACT

A lens cleaning cloth includes a cleaning cloth having a temporary adhesive disposed thereon to enable the cleaning cloth to be temporarily attached to a necktie. Preferably, the temporary adhesive allows the cleaning cloth to be removed without damaging the tie and also dissolves in dry cleaning fluid, allow the cleaning cloth to be removed when dry cleaning the tie without ruining the tie.

### RELATED APPLICATIONS

The present application claims the benefit of U.S. Provisional Application Ser. No. 60/989,550, filed Nov. 21, 2007, which is incorporated herein by reference in its entirety.

### BACKGROUND OF THE INVENTION

1. The Field of the Invention

The present invention relates to an apparatus and method for cleaning eyeglasses and displays. More specifically, the present invention relates to a cloth which is removably attached to a tie for cleaning glasses and displays and which allows for easy disposal when no longer needed.

2. State of the Art

Those who wear glasses will readily appreciate that throughout the day oils from the skin and airborne dust and other contaminants cling to the lenses of a pair of glasses. Over the course of a day the build-up of oils and other contaminants can substantially interfere with the comfort and ability of a person to see through their lenses. Thus, it is common for a person who wears glasses to periodically remove them and wipe them with a cloth or other article of clothing. For example, it is common for men to take off their glasses and rub the lenses with their shirt in order to remove smudges, dust and the like. While the glasses are cleaner, oils, dust and other items are left on the shirt or other article of clothing.

Likewise, some men will use their tie to clean their glasses. Obviously, over time the oils on the glasses will build up on the tie, thereby requiring cleaning. As ties generally require dry cleaning, the ties are typically not frequently cleaned and will accumulate dirt and oils if used to clean glasses. Accumulated dirt on the tie may damage the glasses. Additionally, any uneven or rough surface along the glasses may snag the tie material thereby damaging the tie.

While carrying a handkerchief or a cleaning cloth is an ideal approach to cleaning dirty glasses lenses, many individuals simply forget to carry a cleaning cloth or routinely misplace a cleaning cloth so that it is not available when the glasses need to be cleaned. Thus, many people simply resort to using an article of clothing which may damage the lens and/or the article of clothing over time.

The desirability of having some mechanism for cleaning glasses which cannot be easily forgotten is demonstrated by U.S. Pat. Nos. 6,115,841 (Thompson I I et al.) and 6,233,741 (Lorvee et al.). Thompson and Lorvee teach forming a man's necktie to include one or more pieces of microfiber cloth. A neck tie typically includes the outer shell—which is usually made of silk, an interlining which is somewhat firmer than the silk so as to provide form to the tie, and a tipping—which may be made of silk or other material to cover the ends of the tie left open when the outer shell is folded over. In Thompson and Lorvee the microfiber cloth thus replaces the conventional silk (or other material) tipping material on the underside of the tie.

The use of a tie having microfiber cloth is advantageous over the prior art in that it keeps a cleaning fabric readily available for cleaning lenses when needed. Unlike a handkerchief, the cleaning material cannot be easily lost. However, having the cleaning cloth sewn as part of the tie has several disadvantages. For example, if the user's glasses are frequently dirty, the microfiber material may become sufficiently laden with dirt, oil, etc. that the tie must be dry cleaned. However, it is desirable not to have ties dry cleaned too often, as the tie will often lose its initial shape and will begin to look worn. Thus, a person who must frequently clean their glasses will be forced to dry clean their ties more often than normally required.

Additionally, the use of the sewn-in microfiber material is disadvantageous as it is only available when one happens to be wearing a tie having such material sewn in. Thus, to ensure that he always has a cleaning material, a user must buy only ties having the microfiber cleaning cloth, limiting the user's choice of ties. However, the purchase of ties is usually based on whether the user likes the design of the tie and not whether the tie includes a material for cleaning one's glasses.

Additionally, the use of smartphones, PDAs and small notebook computers has increased the need for a material to clean the screen. Devices which are used as a telephone or which have a touch screen commonly come into contact with oils from the user's ears or hands. These can leave smudges which make it more difficult to view items through the display. Additionally, dirt can be attracted to the oils, making the screen even more difficult to use. Thus, it is not uncommon for individuals to use a shirt sleeve or other piece of clothing to clean the display to remove smudges.

Thus, there is a need for an improved device for providing a cleaning cloth for a wearer of glasses, without the drawbacks associated with the prior art.

### SUMMARY OF THE INVENTION

It is an object of the invention to provide an improved cleaning cloth for use by wearers of glasses and the like which is readily available when needed.

It is another object of the invention to provide an improved cleaning cloth for use by users of cellular telephones, PDAs, computers and the like.

The above and other objects of the invention are accomplished in a cleaning cloth which is cut so as to be disposable on the backside of a tie such that the cleaning cloth may be attached to the tie without being visible from the front side.

In accordance with one aspect of the invention, the cleaning cloth has a removable adhesive disposed on one side thereof to facilitate a temporary and removable attachment of the cleaning cloth to the tie. In such a configuration, the cleaning cloth can be attached to a tie at the beginning of the day and remain in place throughout the day. The cleaning cloth is readily available whenever such is needed. However, if the cleaning cloth becomes overly soiled, the wearer can simply remove the cloth from the tie by a quick pull on a corner of the cleaning cloth. The soiled cloth can then be thrown away and, if desired, a new cleaning cloth can be attached.

In accordance with another aspect of the invention, the cleaning cloth is coated with an adhesive which dissolves in dry cleaning solution, such as acrylic adhesive transfer tape sold by 3M Corporation and several other manufacturers. The acrylic adhesive transfer tape attaches easily to microfiber and other materials and allows those materials to be removably adhesively attached to a tie, but dissolves in perchloroethylene dry cleaning solution. Thus, for example, if the cleaning cloth is left on a tie when the tie is delivered to be dry cleaned, the adhesive holding the cleaning cloth to the tie will dissolve while the tie is being cleaned and the cloth simply falls away from the tie.

Thus, multiple cleaning cloths can be used on a tie in a single day if necessary without ever requiring cleaning of the tie. However, the cleaning cloth will be disposed of at least as often as the tie is dry cleaned. This ensures that a clean cloth is always available to the wearer. Additionally, because the cleaning cloth carries its own adhesive, it can be attached to any tie desired by the wearer—eliminating the need to buy any particular brand of tie.

### BRIEF DESCRIPTION OF THE DRAWINGS

Various embodiments of the present invention are shown and described in reference to the numbered drawings wherein:

FIG. 1 shows a perspective view of a tie having a cleaning cloth attached thereto in accordance with principles of the present invention;

FIG. 2 shows a fragmented view of a tie with an alternate embodiment of a cleaning cloth attached thereto;

FIG. 3 shows an alternate placement of a cleaning cloth in accordance with the present invention;

FIG. 4 shows yet another embodiment of a cleaning cloth attached to a tie in accordance with the principles of the present invention;

FIG. 5 shows an exploded view of a cleaning cloth as it would typically be sold for attachment to a tie.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Several aspects from different figures may be used in accordance with the present invention in a single structure. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

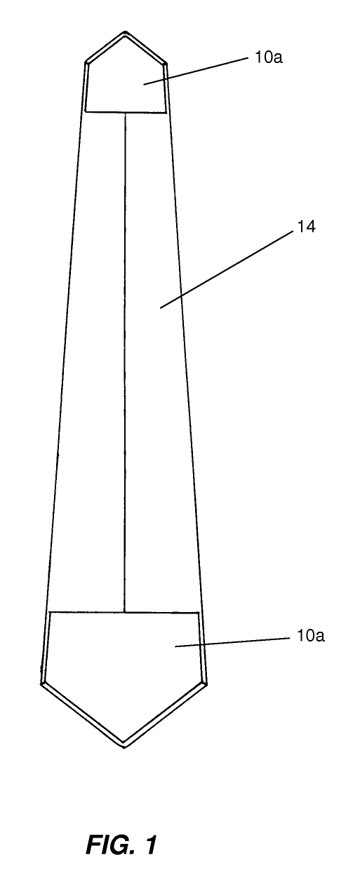

Turning now to FIG. 1 there is shown a pair of cleaning cloths 10a attached to a tie 14 in accordance with the principles of the present invention. Unlike the prior art wherein the cleaning cloths are formed as a part of the tie, the cleaning cloth(s) 10a of the present invention is provided with a removable adhesive which holds the cleaning cloth to the tie. In such a manner, the cleaning cloth may be used until it is sufficiently soiled with oil, dirt, etc. and then may be pulled off the tie by simply grabbing one corner and quickly pulling the corner away from the tie.

The cleaning cloth(s) 10a may also be pulled off for any other reason. Thus, prior to a very formal occasion, the wearer may remove the cleaning cloth(s) so that they will not be visible if the tie 14 were to be turned around by movement, etc. Rather the original tipping of the tie 14 would be visible—if such were important.

It will be appreciated that the cleaning cloth(s) 10 could be any desirable shape. However, a pentagon shape as shown in FIG. 1 is generally desirable as it maximizes surface area adjacent the end of the tie, without the cleaning cloth extending beyond the tie in any direction so as to remain concealed behind the tie.

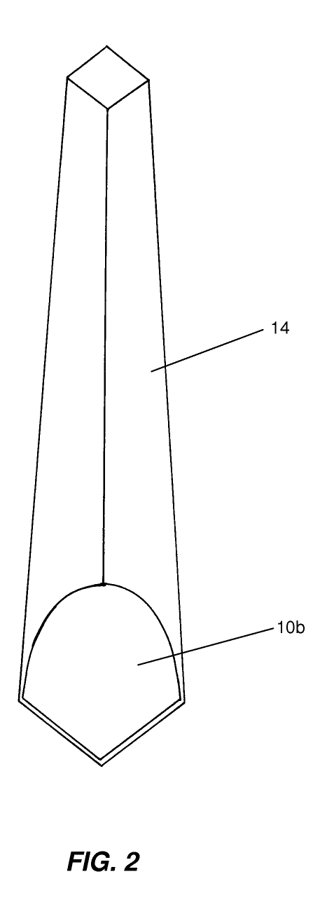

Turning now to FIG. 2, there is shown an alternate configuration of a cleaning cloth 10b which would be attached to a tie. The cleaning cloth 10b can be of any desired shape and a wide variety of sizes. For example, the cleaning cloth could extend substantially up the backside of the tie 14, or could simply be sized to be slightly larger than the generally triangular bottom of the tie. Thus, a user may choose a size of cleaning cloth which is most effective for his needs. A person who has a larger pair of glasses or is prone to clean the glasses more often may choose a larger cleaning cloth, while a person who only needs to periodically remove a smudge may choose a very small cleaning cloth which would be virtually unnoticeable. Likewise, a person who uses a cellular telephone and a notebook computer and dislikes smudges on the display screen may use a larger cleaning cloth.

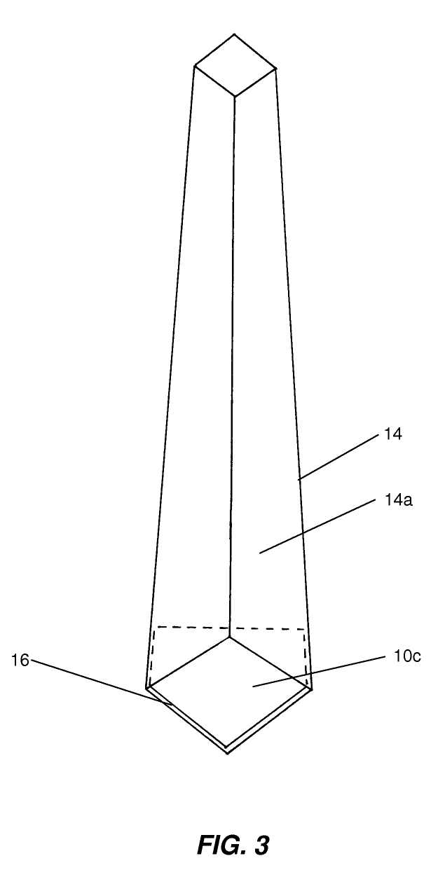

Turning now to FIG. 3, there is shown yet another configuration of a cleaning cloth 10c attached to the tie. Rather than attaching over the seam and forced onto the backside of the outer shell 14a of the tie 14, the cleaning cloth 10c is nested within the hollow formed at the end of the tie—i.e. only on the tipping 16, so as to render the cleaning cloth virtually invisible unless the tie is turned completely around. Again, whether a person would choose this configuration would likely depend on whether the person frequently cleans their glasses, cell phone, PDA and/or computer or does so infrequently. Such a configuration is advantageous as being less noticeable, but disadvantageous in providing less of a surface to wipe the lenses of the glasses on.

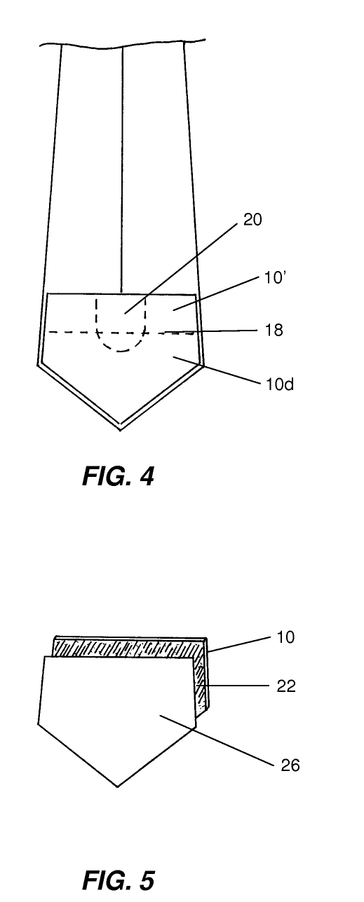

Turning now to FIG. 4 there is shown yet another configuration of a cleaning cloth 10d adhesively attached to the tie 14 (the tie being fragmented). It is noted that only a portion of the cleaning cloth 10d is attached to the tie 14 with a further portion 10′ above the dashed line 18 being beyond the attached area and capable of folding over. This allows a person an easier grip to reach in and use opposing pieces of the cleaning cloth 10d to clean both the front side and backside of a pair of glasses. Alternatively the adhesive could be attached to the cleaning cloth so as to provide a space 20 where a user could slide their finger between the cleaning cloth and the tie to thereby provide gripping on both sides of the cleaning cloth 10d without touching the tie.

FIG. 5 shows an exploded view of a cleaning cloth 10, (such as cleaning cloths 10a-10d shown herein) as it may be sold. The cleaning cloth 10 is typically formed from microfiber material, but cotton and other low abrasion materials may also be used. An adhesive layer 22 is applied to one side of the cleaning cloth 10 to enable the cloth to temporarily hold to the back side of a tie. It will be appreciated that one entire side or any part thereof of the cleaning cloth could have adhesive thereon. It will be appreciated that other temporary fasteners, such as velcro, could also be used. However, such are generally less desirable than a removable adhesive due to cost and handling issues.

A removable backing material 26 is included to preserve the adhesive layer 22 until the cleaning cloth 10 is ready for use. When needed, the cleaning cloth 10 is used by pulling the removable backing material 26 off the adhesive layer 22 and attaching the adhesive layer attached to the backside of the tie. In a moment the cleaning cloth is securely fastened to the tie and is ready for use. If the user desires to remove the cleaning cloth—for example he is attending a social event where he does not want the cleaning cloth 10 to be noticed, he must only give a quick pull on one of the sides and draw it away from the tie to remove the cleaning cloth.

Thus there is disclosed a lens cleaning device and method of use. It will be appreciated that numerous changes may be made to the present invention without departing from the scope of the claims.

What is claimed is:

1. A cleaning cloth for attachment to a man's necktie, comprising:
a cleaning cloth formed from a low abrasion material; and
a temporary adhesive layer for temporary attachment of the cleaning cloth to the necktie.

2. The cleaning cloth according to claim 1, wherein the cleaning cloth is microfiber.

3. The cleaning cloth according to claim 1, further comprising a removable backing layer attached to the adhesive layer to protect the adhesive layer prior to use.

4. The cleaning cloth of claim 1, wherein the temporary adhesive dissolves when laundering the tie.

5. The cleaning cloth of claim 1, wherein the temporary adhesive dissolves when dry cleaning the tie.

6. The cleaning cloth of claim 1, wherein the cloth is shaped to cover the tipping of the neck tie.

7. The cleaning cloth of claim 1, wherein the temporary adhesive layer allows for repositioning of the cloth.

8. A method for providing a cleaning cloth for cleaning glasses or electronic displays, the method comprising:
selecting a cleaning cloth having an adhesive layer; and
attaching the cleaning cloth to the back side of a necktie so as to hold the cleaning cloth to the necktie.

9. The method according to claim 8, wherein the method comprises using an adhesive configured to removably hold the cleaning cloth to the necktie without damaging the necktie when the cleaning cloth is removed.

10. The method according to claim 8, further comprising covering the adhesive layer with a removable backing.

11. The method according to claim 8, wherein the cleaning cloth is configured to cover nearly all of a tipping of the necktie and at least a portion of a seam along the back of the necktie.

12. The method of claim 8, wherein the method comprises selecting a cleaning cloth comprising a cloth layer, an adhesive layer, and a backing layer.

13. The method of claim 8, wherein the method comprises laundering the tie to remove the cloth after using the cloth to clean a desired item.

14. The method of claim 8, wherein the cloth comprises a microfiber cloth.

15. A method for providing a cleaning cloth for cleaning an item comprising:
selecting a cleaning cloth comprising a cloth layer and an adhesive layer;
attaching the cleaning cloth to the back side of a necktie via the adhesive layer;
cleaning an item; and
laundering the neck tie to remove the cleaning cloth.

16. The method of claim 15, wherein the method comprises attaching the cleaning cloth to an end of the neck tie.

17. The method of claim 15, wherein the cloth layer comprises microfiber.
